(19) United States
(12) Patent Application Publication
(10) Pub. No.: US 2007/0113446 A1
(43) Pub. Date: May 24, 2007

(54) Car decorations

(76) Inventors: Samantha Shwartz, New Orleans, LA (US); Carolyn Udell, Metairie, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/136,085

(22) Filed: May 23, 2005

Related U.S. Application Data
(60) Provisional application No. 60/573,476, filed on May 21, 2004.

(51) Int. Cl. G09F 21/04

(52) U.S. Cl. 40/591

(57) ABSTRACT

A car decoration which is similar to the college flags that are attached to car windows on the way to a ball game, but instead of a flag there is a three-dimensional projection reflecting the season (such as devil horns or cat ears for Halloween, bunny ears for Easter, leprechaun ears for St. Patrick's Day, and reindeer antlers for Christmas).

### CROSS-REFERENCE TO RELATED APPLICATIONS

Priority of U.S. Provisional Patent Application Ser. No. 60/573,476, filed May 21, 2004, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to decorations. More particularly, the present invention relates to car decorations.

2. General Background of the Invention

College flags are sometimes attached to car windows on the way to a ball game. They are often attached with a bracket that is attached to a car window when it is partially down, and is held in place when the window is up.

The following U.S. patents are incorporated herein by reference:

U.S. Pat. Nos. 5,836,261 5,477,437 5,016,145 4,916,584 D-264,063 4,582,017 6,247,423 4,526,820

U.S. Patent No. D-264,063 discloses a 3-D pennant.

U.S. Pat. Nos. 5,016,145 and 5,477,437 disclose vehicle decorations with a Christmas theme.

U.S. Pat. Nos. 4,526,820, 6,247,423 and 4,582,017 disclose 3-D decorations for vehicles.

U.S. Pat. No. 4,916,584 discloses a reindeer antler display for a vehicle.

### BRIEF SUMMARY OF THE INVENTION

This is a product for whimsical seasonal decorations for vehicles. It is the objective of this invention to provide ease of application and removal of product for changing them according to season or event.

The above-mentioned objectives are achieved by using a similar apparatus now seen attached to vehicle windows in the form of a flagpole with attached flag, e.g. US flag, college team flags. For ease of reference throughout this document, the supporting structure will be referred to as the “stanchion.”

The decoration, which would vary according to holiday or event, would be affixed to the stanchion. The stanchion would easily attach to the vehicle's driver and passenger side windows to display a whimsical, symmetrical appearance to onlookers, transforming the automobile in one case into a reindeer for Christmas; in another case into a devil for Halloween.

Four possible designs, both using the stanchion, are: 1) inflatable plastic material using a straight stanchion for support; or 2) the decoration formed by means of the stanchion itself; or 3) the decoration formed by means of the stanchion itself wherein a light source via battery pack, solar power, or electricity creates the illusion of an illuminated decoration; or 4) another variation of the stanchion to include a springlike mechanism for added movement and aerodynamics.

The present invention includes a car decoration which is similar to the college flags that are attached to car windows on the way to a ball game, but instead of a flag there is a projection reflecting the season (such as devil horns or cat ears for Halloween, bunny ears for Easter, leprechaun ears for St. Patrick's Day, and reindeer antlers for Christmas). All Christmas decorations are preferably adorned with red Christmas bows and/or bells.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a side perspective view of how the base of the stanchion attaches to a vehicle window.

FIG. 2 details an antler as it is positioned on the vehicle window. FIG. 2 also describes the spatial orientation of each branch of the antler.

FIG. 3 establishes the orientation of the vehicle, for purposes of direction, designated as front, rear, left, and right sides.

FIG. 4 follows orientation of FIG. 2, antler drawing. Using a straight stanchion instead of an S-shaped stanchion, Branch D will form the curve of a candy cane.

FIG. 5 shows a horn to be used as a school mascot, e.g., Texas Longhorns.

FIG. 6 shows a horn to be used as a devil Halloween decoration.

FIG. 7 shows a turkey leg to be used as Thanksgiving decoration.

FIG. 8 shows a surfboard to be used as summer vacation/spring break decoration (estimated length to be 1′ to 6′, and preferably 2½′ to 3′).

FIG. 9 shows a colorful beach ball to be used as summer vacation/spring break decoration.

FIG. 10 shows mouse ears to be used as a theme park mascot decoration.

### DETAILED DESCRIPTION OF THE INVENTION

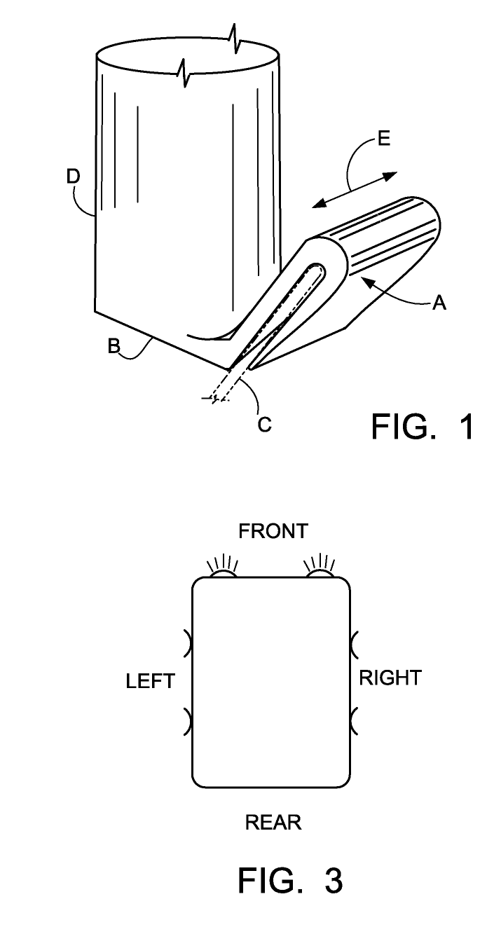

FIG. 1 shows an upside-down “U” attachment A that tapers to form a clamp on the vehicle window. The bracket slips down over the partially opened vehicle window C. To secure the stanchion to the vehicle, the window is rolled up, thereby keeping inclement weather out of the vehicle while keeping the decoration firmly in place. The base of the U-shaped bracket B protrudes out from vehicle window C. From this base B, the stanchion D rises upwards which eventually forms the decoration. U-shaped bracket B can have, for example, a width E of about 4 inches.

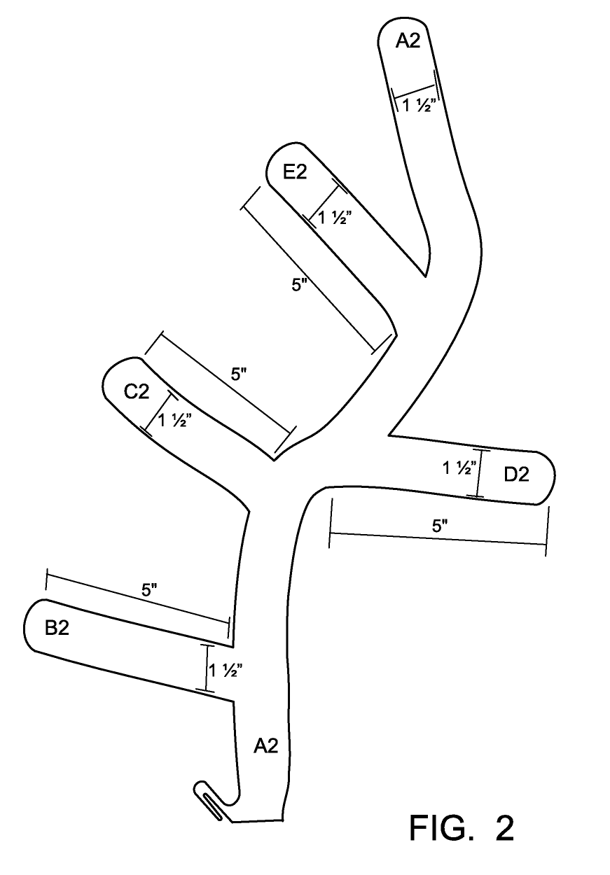

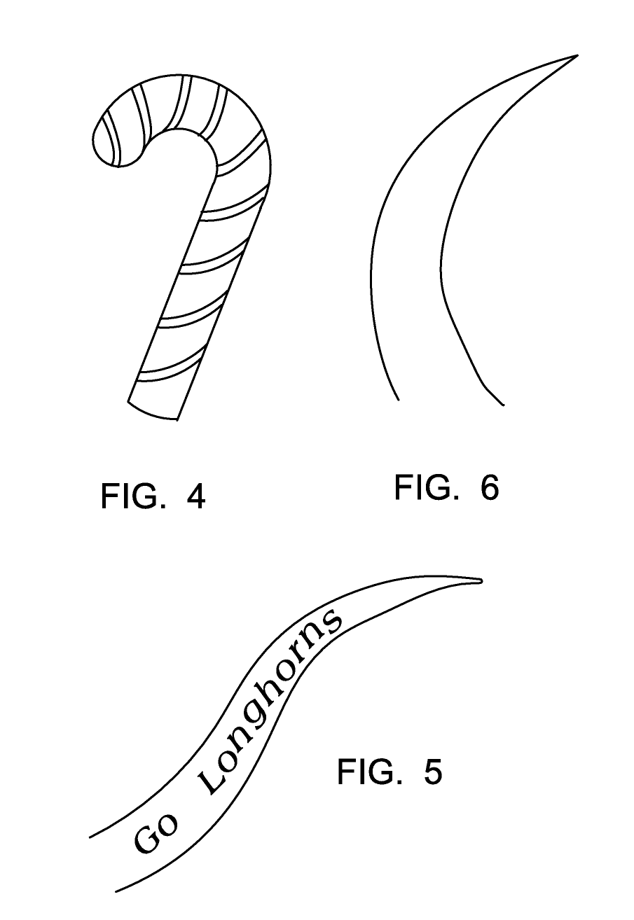

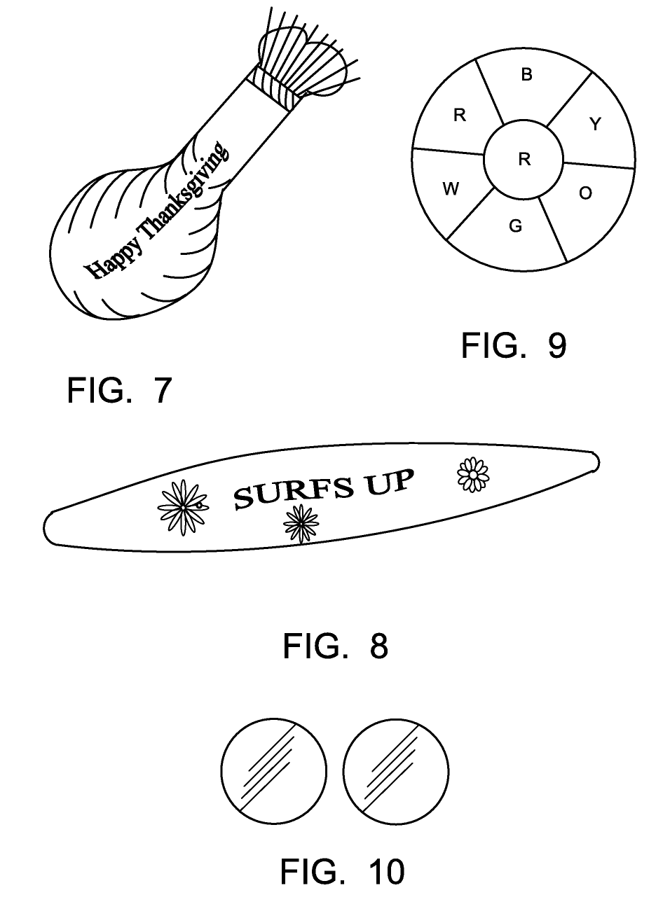

FIG. 2 shows a reindeer antler supported by a stanchion such as the one described in FIG. 1. Main Branch A2 of the antler is a subtle S-shaped curve curving towards the rear of the vehicle from the base of the U-shaped bracket (B in FIG. 1) and inwards to the right side of the vehicle (FIG. 3). The measured height (as with a yardstick) of Main Branch A from the base of the U-shaped bracket (B in FIG. 1) to the top of the stanchion is preferably about 18″. The first S curve of Main Branch A2 preferably starts at about 9½″ from the base of the U-shaped bracket (B). The second S curve of Main Branch A2 preferably starts at about 15″ from the base of the U-shaped bracket (B). The diameter of Main Branch A2 is preferably about 1½″. The measured length (as with a flexible tape measure) of Main Branch A2 from the base of the U-shaped bracket (B) to the tip of the stanchion is preferably about 24″.

Smaller branches protrude from Main Branch A2, each of which is preferably about 5″ in length, preferably about 1½″ in diameter. At preferably about 4″ from the base of the U-shaped bracket (B) begins Small Branch B2. Small Branch B2 preferably forms about a 90-degree angle with respect to Main Branch A2 and parallel with respect to the vehicle window © in FIG. 1). The tip of Small Branch B2 is preferably oriented towards the front of the vehicle (FIG. 3).

At preferably about 9½″ from the base of the U-shaped bracket (B) begins Small Branch C2. Small Branch C2 preferably forms about a 90-degree angle with respect to Main Branch A2 and preferably about a 45-degree angle with respect to the vehicle window (C). The tip of Small Branch C2 is preferably oriented towards the right of the vehicle (FIG. 3).

At preferably about 10″ from the base of the U-shaped bracket (B) begins. Small Branch D2. Small Branch D2 preferably forms about a 45-degree angle with respect to Main Branch A2 and preferably about a 45-degree angle with respect to the vehicle window (C). The tip of Small Branch D2 is preferably oriented towards the left of the vehicle (FIG. 3).

At preferably about 14″ from the base of the U-shaped bracket (B) begins Small Branch E2. Small Branch E2 preferably forms about a 45-degree angle with respect to Main Branch A and about parallel with respect to the vehicle window C). The tip of Small Branch E2 is preferably oriented upwards (north), away from the roof of the vehicle (FIG. 3).

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. Apparatus for decorating vehicles, comprising:
a stanchion for attaching to a window of a vehicle, the stanchion including an upside-down U-shaped bracket that tapers to form a clamp on the vehicle window, wherein the bracket is shaped to slip down over a partially opened vehicle window and to secure the stanchion to the vehicle when the window is rolled up, and wherein the base of the upside-down U-shaped bracket protrudes out from vehicle window when the window is rolled up; from the base, the stanchion rises upwards and forms a three-dimensional, non-flat decoration, or a three-dimensional, non-flat decoration is attached to the stanchion.

2. The apparatus of claim 1, wherein the decoration commemorates a holiday or holiday season.

3. The apparatus of claim 1, wherein the decoration is one from the group consisting of a reindeer antler, a devil horn, a longhorn cattle horn, a candy cane, a cat ear, a bunny ear, a leprechaun ear, a turkey drumstick, a beach ball, a surfboard, and mouse ears.

4. The apparatus of claim 1, wherein the decoration is made of inflatable plastic material using a straight stanchion for support.

5. The apparatus of claim 1, wherein the stanchion is shaped to form the decoration.

6. The apparatus of claim 1, wherein the measured distance from the bracket to the top of the decoration is about 5″-6′.

7. The apparatus of claim 1, wherein the measured distance from the bracket to the top of the decoration is about 10″-3′.

8. The apparatus of claim 1, wherein the measured distance from the bracket to the top of the decoration is about 15″-21″.

9. A method of decorating a vehicle, comprising attaching one or more of the apparatus of claim 1 to a window or windows of the vehicle.

10. (canceled)

11. Apparatus for decorating vehicles, comprising:
a stanchion for attaching to a window of a vehicle, the stanchion including an upside-down U-shaped bracket that tapers to form a clamp on the vehicle window, wherein the bracket is shaped to slip down over a partially opened vehicle window and to secure the stanchion to the vehicle when the window is rolled up, and wherein the base of the upside-down U-shaped bracket protrudes out from vehicle window when the window is rolled up; from the base, the stanchion rises upwards and forms a three-dimensional, non-flat decoration, or a three-dimensional, non-flat decoration is attached to the stanchion, wherein:
the decoration commemorates a holiday or holiday season, and the decoration is one from the group consisting of a reindeer antler, a devil horn, a cat ear, a bunny ear, a leprechaun ear.

12. The apparatus of claim 11, wherein the decoration is made of inflatable plastic material using a straight stanchion for support.

13. The apparatus of claim 11, wherein the stanchion is shaped to form the decoration.

14. The apparatus of claim 11, wherein the measured distance from the bracket to the top of the decoration is about 5″-6′.

15. The apparatus of claim 11, wherein the measured distance from the bracket to the top of the decoration is about 10″-3′.

16. The apparatus of claim 11, wherein the measured distance from the bracket to the top of the decoration is about 15″-21″.

17. A method of decorating a vehicle, comprising attaching one or more of the apparatus of claim 11 to a window or windows of the vehicle.

18. Apparatus for decorating vehicles, comprising:
a stanchion for attaching to a window of a vehicle, the stanchion including an upside-down U-shaped bracket that tapers to form a clamp on the vehicle window, wherein the bracket is shaped to slip down over a partially opened vehicle window and to secure the stanchion to the vehicle when the window is rolled up, and wherein the base of the upside-down U-shaped bracket protrudes out from vehicle window when the window is rolled up; from the base, the stanchion rises upwards and forms a three-dimensional, non-flat decoration, or a three-dimensional, non-flat decoration is attached to the stanchion, wherein the decoration is made of plastic material using a straight stanchion for support.

19. The apparatus of claim 18, wherein the decoration commemorates a holiday or holiday season.

20. The apparatus of claim 18, wherein the decoration is one from the group consisting of a reindeer antler, a devil horn, a longhorn cattle horn, a candy cane, a cat ear, a bunny ear, a leprechaun ear, a turkey drumstick, a beach ball, a surfboard, and mouse ears.

21. The apparatus of claim 18, wherein the measured distance from the bracket to the top of the decoration is about 5″-6′.

22. The apparatus of claim 18, wherein the measured distance from the bracket to the top of the decoration is about 10″-3′.

23. The apparatus of claim 18, wherein the measured distance from the bracket to the top of the decoration is about 15″-21″.

24. A method of decorating a vehicle, comprising attaching one or more of the apparatus of claim 18 to a window or windows of the vehicle.
